(19) United States
(12) Patent Application Publication
(10) Pub. No.: US 2018/0010351 A1
(43) Pub. Date: Jan. 11, 2018

(54) METHOD OF USING COLLAPSIBLE KIOSK

(71) Applicant: Megan Berry, Santa Monica, CA (US)

(72) Inventor: Megan Berry, Santa Monica, CA (US)

(21) Appl. No.: 15/644,192

(22) Filed: Jul. 7, 2017

Related U.S. Application Data
(60) Provisional application No. 62/359,459, filed on Jul. 7, 2016.

(51) Int. Cl. E04H 1/12; A47B 43/00; G09F 15/00; E04H 1/00

(52) U.S. Cl. CPC E04H 1/1222; G09F 15/0006; E04H 1/12; A47B 43/00; E04H 1/00; G09F 15/00

(57) ABSTRACT

A method of using a collapsible kiosk is provided which includes providing a collapsible kiosk. The collapsible kiosk includes a plurality of walls, a roof connecting the plurality of walls and forming an interior space, and at least one sensor. The collapsible kiosk is at least partially made of a barrier to prevent interference for the at least one sensor.

### CROSS-REFERENCE TO RELATED APPLICATIONS

This application claims priority to U.S. Provisional Patent Application No. 62/359,459 which was filed in the U.S. Patent and Trademark Office on Jul. 7, 2016, all of which is incorporated herein by reference in its entirety.

### FIELD

The embodiments of the present disclosure relate generally to a kiosk. More particularly, the embodiments of the present disclosure relate to a kiosk that is collapsible for easy set up and disassembly.

### BACKGROUND

Pop up kiosks, or pop up shops, allow small vendors to provide merchandise at various locations as desired. For example, the retailer can have a kiosk on sidewalks, in parks and public places, at sporting events, festivals, fashion shows, or conventions. Accordingly, the kiosk provides a space to display merchandise at any desired location without the need for a physical storefront.

### BRIEF DESCRIPTION OF THE DRAWINGS

Preferred embodiments of the present invention are disclosed in the accompanying drawings, wherein similar reference characters denote similar elements throughout the several views, and wherein:

FIG. 1 shows an exploded view of an embodiment of a collapsible kiosk;

FIG. 2A shows an isometric view of a top hinge for a collapsible kiosk;

FIG. 2B shows an isometric view of a bottom hinge for a collapsible kiosk;

FIG. 3A shows an isometric view of a collapsible kiosk in an open configuration;

FIG. 3B shows a top cross-sectional view of a collapsible kiosk in an open configuration;

FIG. 4A shows an isometric view of a collapsible kiosk in a room configuration, such as a fitting room;

FIG. 4B shows a top cross-sectional view of a collapsible kiosk in a transition configuration;

FIG. 5A shows an isometric view of a collapsible kiosk in a closed configuration; and

FIG. 5B shows a top cross-sectional view of a collapsible kiosk in a closed configuration.

### DETAILED DESCRIPTION

The embodiments of the present invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will convey the scope of the invention to those skilled in the art.

In the following description, like reference characters designate like or corresponding parts throughout the figures. Additionally, in the following description, it is understood that terms such as “top,” “bottom,” “upper,” “lower,” “inside,” “outside” and the like, are words of convenience and are not to be construed as limiting terms.

While the disclosure focuses on a collapsible kiosk, the term pop up shop can be used and is interchangeable with kiosk. Additionally, other terms known in the art can be utilized so long as the structure is collapsible and can be reassembled and erected at different locations, providing a portable structure to showcase products.

A collapsible kiosk can be erected at various locations to provide a structure to showcase products. As the collapsible kiosk is not a permanent structure, a vendor does not have to invest as much time, money, and paperwork to obtain a storefront. The collapsible kiosk provides a portable structure which has shelves and displays for products. The collapsible kiosk can have doors which, when closed, can provide a locked and secure interior space for the products when the collapsible kiosk is closed for business. When opened, the interior space of the collapsible kiosk is accessible for customers to peruse the products. Further, the doors of the collapsible kiosk can open partially. When an enclosure element such as a curtain is connected, the doors, the outside wall of the collapsible kiosk, and the enclosure combine to form a space for a room—for example a fitting room including a technology product demo with voice command and touch screen to enable a virtual fitting mirror and/or visual search to request store associate assistance, test products or make purchases via voice, touch screen, or mobile application; a photobooth; and/or additional merchandising space. The kiosk having a fitting room provides the customer a place to try on apparel at the kiosk while maintaining privacy. Otherwise, the customer or shopper is in full public view. Accordingly, the collapsible kiosk provides the customer with a full experience with consumer products or experiences.

The collapsible kiosk also includes cameras and sensors. The cameras and sensors provide analytics, statistics, and records on the products as well as the shopper. The cameras can track the customers' demographics and movements while the sensors can track the products. Algorithms can then be used to combine the data from the cameras and the sensors to provide a full analysis of shoppers' tendencies and interest in the products. Examples of data that can be obtained are: customer dwell time in kiosk (length of time in kiosk); length of time of product consideration (length of time the product is away from its display area—thus picked up from customer); product movement into the fitting room (measuring how often a product is tried on); product conversion (how often a product is sold and overlays with the time of consideration and how long it takes for a customer to first see product, engage, demo or try on, and then convert to a sale).

The camera analytics and sensors, when used in a kiosk, provide better data as the sample size is smaller. The kiosk may only display, for example, one of each size of a shirt, instead of tens of the same shirt in the same size all stacked on top of one another, as in a larger store. Also, as the kiosk is a smaller space, not as many customers can browse at once. Thus, the cameras and sensors can track each product and customer with greater success. Further, the cameras and sensors would not interfere with one another as each camera and sensor can be placed strategically to focus on distinct areas. Moreover, the shelves and/or the panels of the kiosk can include a barrier, for example aluminum siding, such that the sensors do not interfere with one another.

Therefore, the kiosk provides for a full customer experience while providing detailed analytics for the retailer.

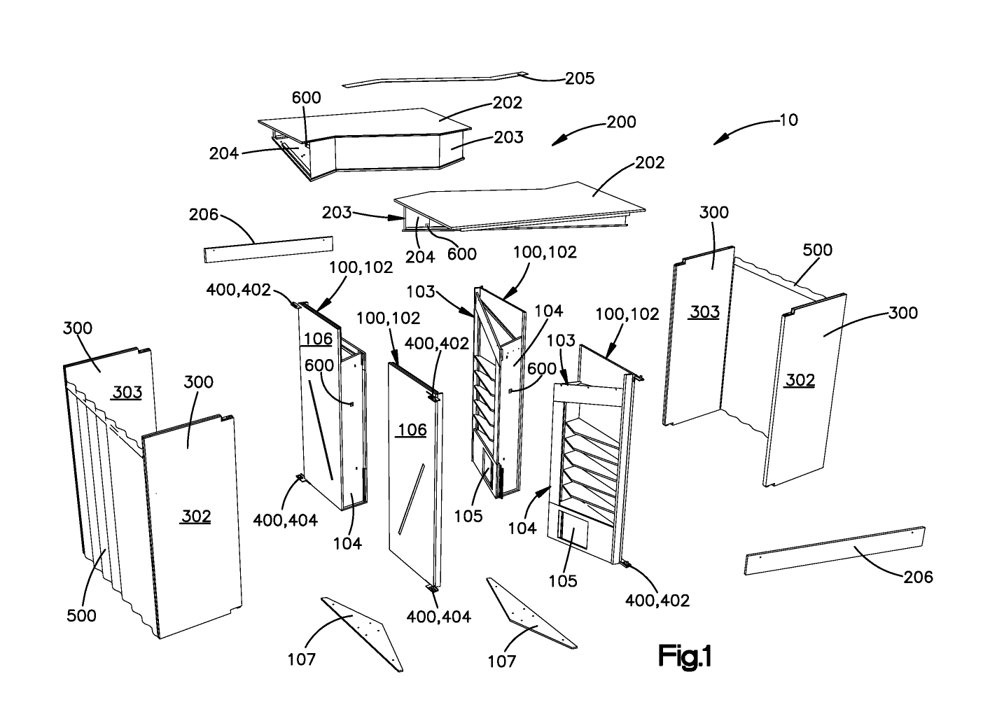

FIG. 1 shows an exploded view of one embodiment of a kiosk 10 which has two walls 100 and a roof 200. The two walls 100 are opposite one another. The roof 200 connects the two walls, forming an interior space.

In the illustrated embodiment, each of the two walls 100 can be composed of two wall panels 102. In other embodiments, the each of the two walls 100 can be composed of one, three, four, or more panels 102. The wall panels 102 are also supported and coupled by a base 107, which corresponds to the shape of the wall panels 102. The base 107 can have holes which can receive pegs from the wall panels 102 and secured by a bolt. In other embodiments, the base 107 is screwed into the wall panels 107, or is fastened by any suitable method coupling the base to the wall panels. The wall panels 102 can be connected by various methods, for example by tongue and groove configurations, latching together with facets, or any suitable method. In at least one embodiment, the panels are not connected by screws. The walls 100 have an outer surface 106 which faces the exterior of the kiosk 10. On the interior of the kiosk, the walls 100 can have at least one shelving unit 103 coupled thereto. Each of the walls 100 can be made of two wall panels 102 that are mirror images of the other to provide easy disassembly and packaging.

The shelving units 103, as illustrated in FIG. 1, are triangular in shape, but can be any suitable shape, for example rectangular. The shelving units 103 have connecting surfaces 104 which are proximate to one another when the wall panels 102 are connected. In at least one embodiment, the connecting surfaces 104 do not abut one another, forming a central column. The space between the connecting surfaces 104 can be used to pass wires, implement sensors, or serve any desired or suitable purpose. The shelving units 103 can include at least one shelf to hold and display items or products. The shelving units 103 can also include bars, for example to support hangers, separators, or any suitable storage system to display products. While in the illustrated embodiments, the shelving units 103 are all similar, the kiosk 10 is modular such that features of the kiosk can be interchangeable. As such, one wall panel 102 can include a shelving unit 103 including shelves while another wall panel 102 can include a shelving unit 103 with bars for hangers, while yet another wall panel 102 may not have a shelving unit 103 to have space for larger or taller items.

In the illustrated embodiment, the kiosk 10 includes a battery 105. The battery 105 provides power to the kiosk 10 for functions such as cameras, sensors, lights, signs, or any other devices to be used in relation to the kiosk 10. Accordingly, the kiosk 10 can be self-powered and does not rely on any external source of power. The battery 105, as illustrated, can be stored in the bottom of the shelving units 103. In other embodiments, the battery 105 can be stored external to the kiosk 10, in the roof 200, or any suitable location to store a battery 105. In yet other embodiments, the kiosk 10 does not include a battery, and includes a power cable to plug into an external power source, such as a wall outlet or a generator.

The roof 200 is composed of two roof panels 202. In other embodiments, the roof 200 can be composed of one, three, four, or more roof panels 202. The roof panels 202 have connecting surfaces 203 which undulate to provide for ease of alignment. In other embodiments, the connecting surfaces 203 of the roof panels 202 are straight. The roof panels 202 can be coupled by a seal 205. The seal 205 corresponds to the shape of the connecting surfaces 203. The seal 205 plugs the crease between the roof panels 202. In other embodiments, a seal 205 is not provided, and the roof panels 202 overlap one another in such a manner to provide a seal. The roof panels 202 can be connected by various methods, for example by tongue and groove configurations, latching together with facets, or any suitable method. In at least one embodiment, the panels are not connected by screws. The roof 200, as illustrated, is triangular in shape, but can be any suitable shape such as rectangular. The roof 200 has an attic space 204 which can store and provide cables, lighting, speakers, cameras, or any suitable item or device. The roof 200 also includes side panels 206 to provide an abutment for doors 300 as well as provide an aesthetic entrance for customers.

The kiosk 10 can also include one or more sensors 600. The sensors 600 allow the retailer to track, for example, shopping patterns, interest of products, among other data. With that data, the retailer can even track if a shopper looks at a product in the kiosk 10 and then potentially later buys the product at another location in a store, even across the country or internationally. The sensors 600 are product performance sensors and video analytics, including but not limited to, radio frequency identification sensors, cameras, beacon technology, any suitable sensor to detect and track product and customer data, or a combination thereof. The sensors 600 are configured to detect, store, and analyze data. The data can include, but is not limited to, the number of shoppers, the demographics of the shoppers, products that are selected by the shoppers, time of consideration of products by the shoppers, products that are being moved to the fitting room and how often the products are tried on, inventory, shopping patterns of the shoppers, and product conversion. For the length of time of product consideration, the sensors 600 may track the length of time the product is away from its display area while picked up by a shopper. Product conversion relates to how often a product is sold overlaid with the time of consideration. In other words, product conversion may show how long it takes for a customer to first see the product, engage the product, demo or try it on, and then convert that to a sale.

The sensors 600 can be located throughout the kiosk 10. The sensors 600 can be disposed in the center column in between the wall panels 102. In at least one embodiment, the sensors 600 can be located between the connecting surfaces 104 of the wall panels 102. Two or more sensors 600 can be placed back to back, each facing towards different wall panels 102 and shelving units 103. In other embodiments, one sensor 600 can be used. The number of sensors 600 can vary so long as data is captured at the desired sections of the kiosk 10. The sensors 600 can also be located within the shelving units 103. The angles of the shelving units 103 allow for various technologies to be used for brand or category specific uses in a controlled environment, which is very different from what malls do today. Additionally, the sensors 600 can be located within the roof 200 or between the two roof panels 202. Further, the sensors 600 can be located outside of the kiosk 10, for example, to capture data within a fitting room. While the exemplary locations are described to implement the sensors 600, the sensors 600 can be placed at any location in the kiosk 10 suitable to capture data without interference. For example, the sensors 600, such as cameras, may be set up such that the sensors 600 can capture the entrance, the exit, and the interior space of the kiosk 10 to adequately capture data regarding the shoppers.

The kiosk 10 allows for the sensors 600 to function and not compromise each other in such a small area. A barrier can be included in the shelves of the shelving units 103 to prevent further data from being compromised due to interference and/or misleading proximity. The barrier can also be implemented in the panels of the kiosk 10 such that the sensors 600 can track the products outside of the kiosk 10 such as in a fitting room. The barrier can include a metal, such as aluminum siding, or any suitable material that prevents interference between sensors. As such, because of the materiality and size of the kiosk 10, the sensors 600 can sufficiently capture and track data without interference.

The sensors 600 used in the kiosk 10 do not work in malls or large stores because the sensors in such locations interfere with each other as there are no barriers. For example, shops use glass or wood in its construction which allow for interference. Further, large shops have large inventory where there may be ten or more of one size of one product on display. Moreover, every size of one product may be stacked on top of one another. As customers move the products around, the sensors would have trouble tracking the products. Additionally, as larger stores may have many shoppers inside at once, the sensors may have trouble tracking the movement of individual shoppers. As such, a collapsible kiosk 10 may be set up within the store to provide a sampling of products and allow for the capture of data by the sensors 600.

The two walls 100 and the roof 200 form two openings which can be opposite each other. The openings provide access to the interior space of the kiosk 10.

The kiosk 10 also includes doors 300. The doors 300 are pivotably coupled to the walls 100. As in the illustrated embodiment, each wall 100 has one door 300 pivotably coupled to each of the opposing edges of the walls 100. The doors 300 are configured to rotate at least 270 degrees about the edges of the walls 100.

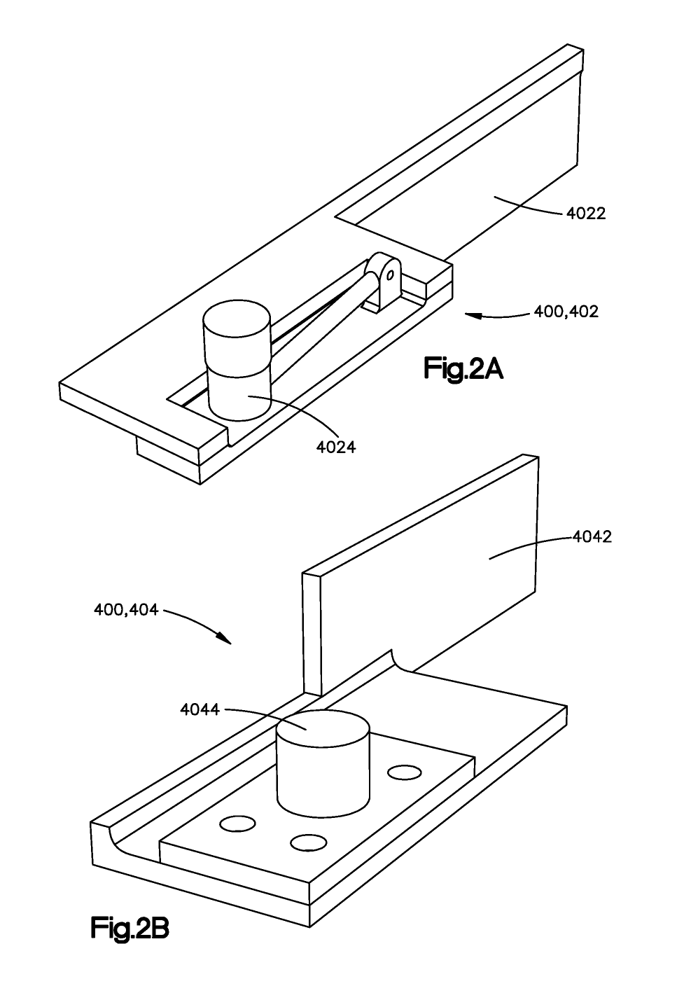

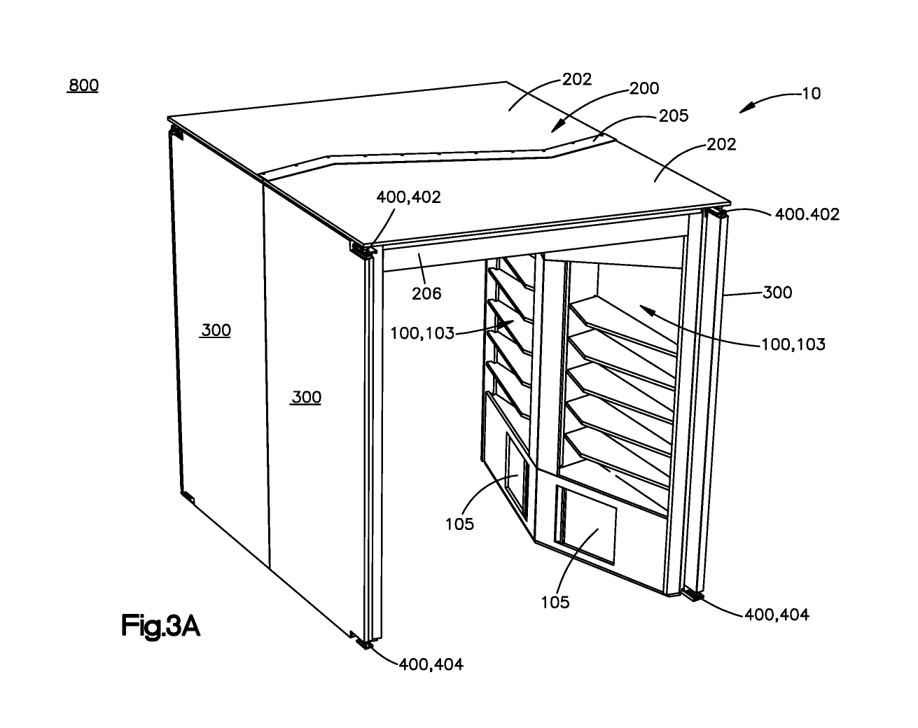

The doors 300 are pivotably supported upon paired hinges 400 which permit the doors to rotate at least 270 degrees without interference with the edges of the walls 100. Illustrated examples of hinges 400 are provided in FIGS. 2A and 2B. FIG. 2A illustrates a top hinge 402, and FIG. 2B illustrates a bottom hinge 404. For the top hinge, an extension 4022 couples to the wall 100. The door 300 pivots about upper pivot point 4024. Upper pivot point 4024 provides a pivoting action which prevents an interference fit between the edge of the wall 100 and the door 300 as the door 300 pivots greater than 180 degrees. The bottom hinge 404 has an extension 4042 which couples to the wall 100. The door 300 pivots about bottom pivot point 4044. Any suitable hinge 400 can be utilized, so long as the doors 300 can pivot at least 270 degrees without interference with the edge of the walls 100.

The doors 300 have an inner side 302 and an outer side 303. When the doors are closed, the inner side 302 faces the inside of the kiosk 10 while the outer side 303 faces external the kiosk 10. As such, when the doors 300 are closed, the kiosk 10 can be vandalized, yet when the doors 300 are opened, the vandalism can be hidden as the inner side 302 is revealed and the outer side 303 is hidden. Also, the inner side 302 and the outer side 303 can have different designs or be made of different material. In other embodiments, the inner side 302 and the outer side 303 can have the same design or be of the same material.

The kiosk 10 can include one or more screens. The screen can be embedded in the doors 300, the walls 100 and/or any other desired location in the kiosk. The screen may be flush with the doors 300 and/or walls 100, or may protrude or be recessed within the doors 300 and/or walls 100. The screen can be placed on the inside and/or the outside of the kiosk 10. The screen provides the customer the ability to do at least one of: request a sales associate to the fitting room or utility room; virtual chat via the touch screen; search, browse, and/or order products via the touch screen; voice-enabled search and/or product selection; virtual fittings via the screens (for example, augmented reality or virtual reality). The screen may be a touch screen and/or the kiosk 10 may include a separate mechanism to control the programs on the screen. Any suitable method to control programs provided on the screen may be utilized. Each screen may be similar, or each screen may be different; for example, one screen may be a touch screen while another screen may be purely visual. In another example, all screen(s) may be touch screens.

The walls 100, the roof 200, and the doors 300 can be made of plastic, wood, metal, or a combination thereof; for example, the walls 100, the roof 200, and the doors 300 can be made of acrylic such as plexiglass, glass, aluminum composite material, sheet metal, wood such as birch wood or plywood, plastics, carbon fiber, insulated materials, structured meshes and screens, any combination thereof, or any suitable material. In at least one embodiment, the kiosk 10 can have dimensions of six feet wide by six feet long. In other embodiments, the dimensions of the kiosk 10 can vary, including the height of the kiosk 10. The kiosk 10 can be assembled and disassembled quickly. For example, the kiosk 10 can be assembled and disassemble within thirty minutes. The kiosk 10, when disassembled, can also be flat packed to provide for convenient shipping.

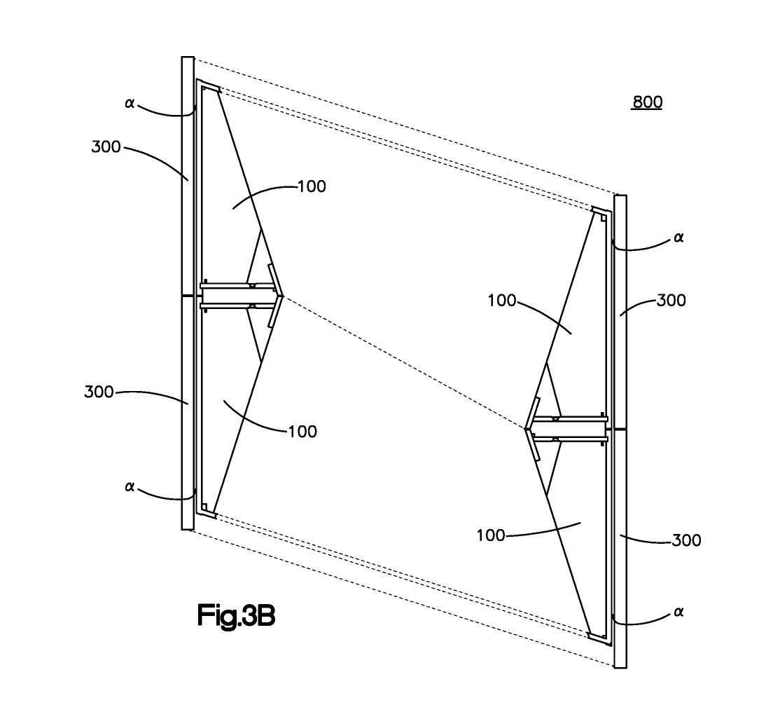

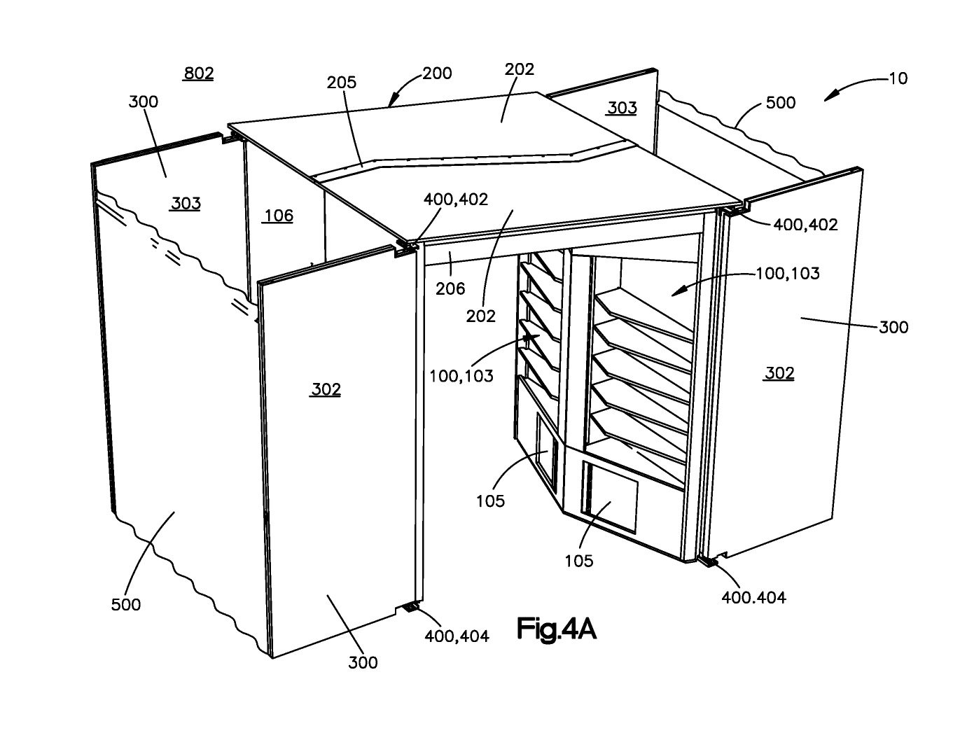

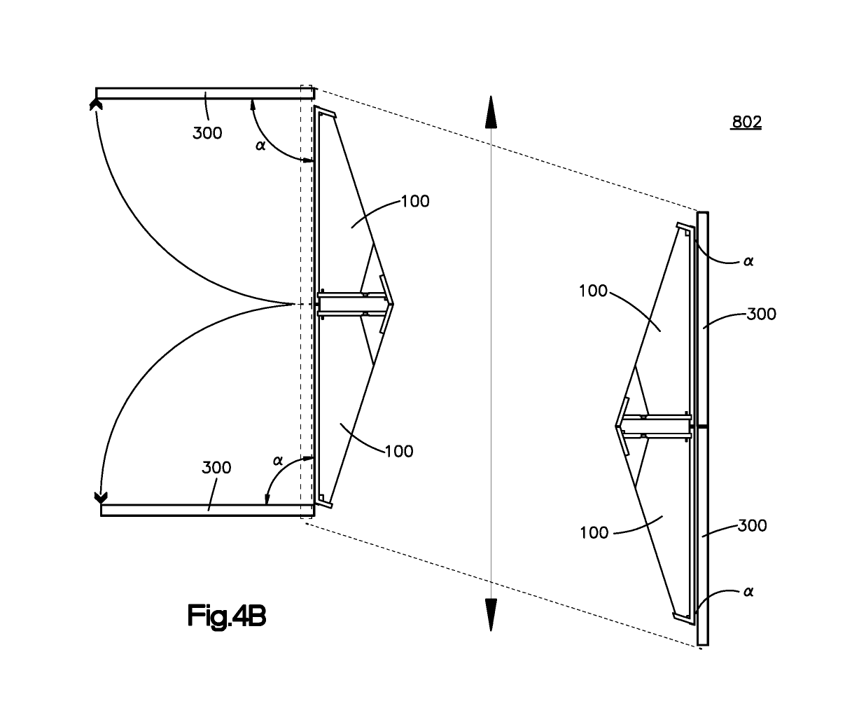

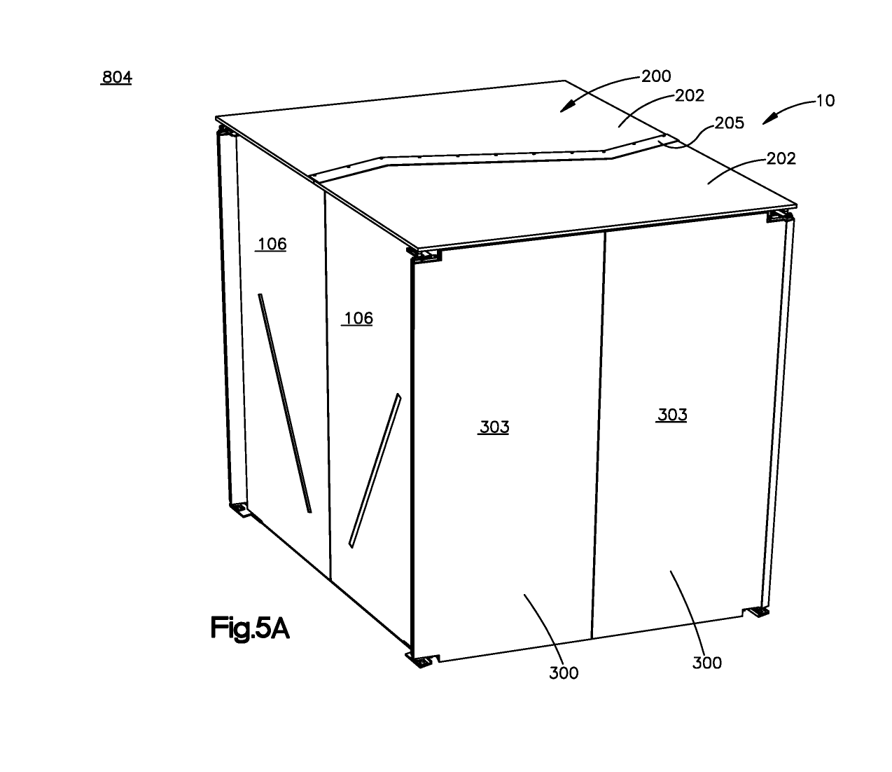

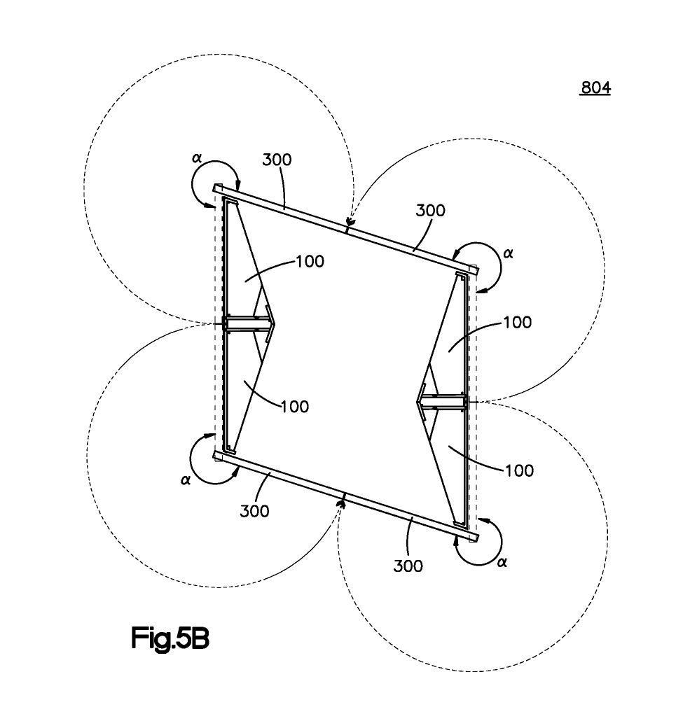

FIGS. 3A-5B illustrate different configurations of the kiosk 10. FIGS. 3A and 3B illustrate the kiosk 10 in an open configuration 800. FIGS. 4A and 4B illustrate the kiosk 10 in a transitional or room configuration 802, where the doors 300 are partially pivoted. FIGS. 5A and 5B illustrate the kiosk 10 in a closed configuration 804, where the doors 300 prevent access to the interior space of the kiosk 10.

When the doors 300 are fully opened, as illustrated in FIGS. 3A and 3B, the doors 300 can abut the outside surface 106 of the walls 100 such that an outer wall is formed external the walls 100. The interior space is accessible for customers to enter and peruse the items displayed within the kiosk 10. The inside surface 302 of the doors 300 form the outer wall. In such a configuration, the inside surfaces 302 of the doors 300 are revealed which hides the design or any vandalism on the outside surfaces 106 of the walls 100. An angle α, which is the angle between the door 300 and the wall 100, when in the open configuration 800, is 0 degrees. In other words, the doors 300 are pivoted about 0 degrees in relation to the wall 100. As such, the doors 300 are substantially parallel with the walls 100, and the outside surface 303 of the doors 300 are proximate to the outside surface 106 of the wall 100.

When partially opened in a room configuration 802 as illustrated in FIGS. 4A and 4B, an enclosure element 500 can be coupled to the doors 300 provide a utility space, such as a fitting room. As such, the kiosk 10 has a fitting room which is not a permanent structure. The kiosk 10 then does not take up a greater area than needed. Further, as the utility space can be created without the need of extra building materials than that of the kiosk 10 itself, space, time, and money can be saved.

In the illustrated embodiment, the utility space is created when the angle α between the doors 300 and the wall 100 is less than 180 degrees. In other words, when in the room configuration 802, the doors 300 are pivoted less than 180 degrees in relation to the wall 100. The outside surfaces 303 of the doors 300, the enclosure element 500, and the outside surface 106 of the walls 100 form the utility space. The utility space is quadrilateral such as a trapezoidal shape. In alternate embodiments, if the door 300 of the kiosk 10 is only one panel, one wall of the utility space can be the outside surface 106 of the wall 100 while another wall of the utility space is formed by the door 300 such that the utility space is triangular. The enclosure element 500, such as a curtain or other material, can be placed between the partially open doors 300 such that the opening formed therein is enclosed. The utility space can be, for example, a fitting room. Thus, the utility space is available utilizing the components already included in the kiosk. This provides a simpler design, easier and cheaper packaging and shipping, and easier assembly and disassembly.

While the illustrated embodiment provides for a kiosk with a utility space formed by pivoting doors, other embodiments may be used to provide a utility space in combination with a kiosk. For example, the doors may slide on railings which, when slid past the walls of the kiosk, can form a utility space such as a fitting room. Any suitable method of creating a kiosk in combination with a utility space such as a fitting room may be utilized.

The doors 300 on opposing walls 100, when in a closed configuration 804 as illustrated in FIGS. 5A and 5B, meet and couple or latch to close the opening and prevent access to the interior space of the kiosk 10. The angle α between the wall 100 and the doors 300 is about 270 degrees. In other words, the doors 300 are pivoted about 270 degrees relative to the wall 100 and abut the side panels 206. In other embodiments, the kiosk 10 only has one set of doors 300 pivotably coupled to one wall 100. The one set of doors 300 would span the entire opening and latch or couple to the opposite wall 100 to close or lock the kiosk 10.

While the embodiments have been described in detail in the foregoing description, the same is to be considered as illustrative and not restrictive, it being understood that only some embodiments have been shown and described and that all changes and modifications that come within the spirit of the embodiments are desired to be protected.

1. A method of using a collapsible kiosk, the method comprising:
providing a collapsible kiosk, the collapsible kiosk including:
a plurality of walls;
a roof connecting the plurality of walls and forming an interior space; and
at least one sensor; and
collecting, by the at least one sensor, data;
wherein the collapsible kiosk is at least partially made of a barrier to prevent interference for the at least one sensor.

2. The method of claim 1, wherein the at least one sensor includes product performance sensors, camera analytics, or a combination thereof.

3. The method of claim 1, wherein the at least one sensor includes radio frequency identification sensors, cameras, beacon technology, or a combination thereof.

4. The method of claim 1, wherein the data collected by the at least one sensor includes number of shoppers, demographics of shoppers, products that are selected by shoppers, time of consideration of products by shoppers, products that are being moved, number of times products are tried on, inventory, shopping patterns of shoppers, product conversion, or a combination thereof.

5. The method of claim 1, wherein the barrier includes a metal.

6. The method of claim 1, wherein the barrier includes aluminum siding.

7. The method of claim 1, wherein the barrier is lined inside the walls.

8. The method of claim 1, wherein the collapsible kiosk further includes at least one shelving unit including at least one shelf; wherein the shelving unit and the at least one shelf is at least partially lined with the barrier to prevent interference for the at least one sensor.

9. A method of using a collapsible kiosk, the method comprising:
providing a collapsible kiosk, the collapsible kiosk including:
a plurality of walls;
a roof connecting the plurality of walls and forming an interior space; and
a plurality of doors coupled to at least one of the plurality of walls; and
forming a utility space by configuring the doors.

10. The method of claim 9, wherein the utility space is a fitting room.

11. The method of claim 9, wherein when forming the utility space, the doors are pivoted about edges of the plurality of walls.

12. The method of claim 11, wherein the doors are pivoted less than 180 degrees.

13. The method of claim 9, wherein the utility space is formed by the doors and the walls of the collapsible kiosk.

14. The method of claim 9, wherein the collapsible kiosk further includes at least one sensor.

15. The method of claim 14, wherein the at least one sensor includes product performance sensors, camera analytics, radio frequency identification sensors, cameras, beacon technology, or a combination thereof.

16. The method of claim 14, wherein the collapsible kiosk is at least partially made of a barrier to prevent interference for the at least one sensor.

17. The method of claim 16, wherein the collapsible kiosk further includes at least one shelving unit including at least one shelf; wherein the shelving unit and the at least one shelf is at least partially lined with the barrier to prevent interference for the at least one sensor.

18. The method of claim 14, further comprising collecting, by the at least one sensor, data.

19. The method of claim 18, wherein the data collected by the at least one sensor includes number of shoppers, demographics of shoppers, products that are selected by shoppers, time of consideration of products by shoppers, products that are being moved, number of times products are tried on, inventory, shopping patterns of shoppers, product conversion, or a combination thereof.

20. A method of using a collapsible kiosk, the method comprising:
providing a collapsible kiosk, the collapsible kiosk including:
a plurality of walls;
a roof connecting the plurality of walls and forming an interior space;
a plurality of doors coupled to at least one of the plurality of walls;
at least one shelving unit including at least one shelf; and
at least one sensor;
collecting, by the at least one sensor, data; and
forming a utility space by configuring the doors;
wherein the at least one sensor comprises product performance sensors, camera analytics, radio frequency identification sensors, cameras, beacon technology, or a combination thereof;
wherein the data collected by the at least one sensor comprises number of shoppers, demographics of shoppers, products that are selected by shoppers, time of consideration of products by shoppers, products that are being moved, number of times products are tried on, inventory, shopping patterns of shoppers, product conversion, or a combination thereof;
wherein the collapsible kiosk is at least partially made of a barrier which includes a metal to prevent interference for the at least one sensor;
wherein the utility space is a fitting room; and
wherein the utility space is formed by the doors and the walls of the collapsible kiosk.
